(19) United States
(12) Patent Application Publication
(10) Pub. No.: US 2023/0052371 A1
(43) Pub. Date: Feb. 16, 2023

(54) HEATING DEVICE CAPABLE OF UNIFORM SEALING

(71) Applicants: Deok Kun Kim, Cheongju-si (KR); Kang Min Lee, Cheongju-si (KR)

(72) Inventors: Deok Kun Kim, Cheongju-si (KR); Kang Min Lee, Cheongju-si (KR)

(21) Appl. No.: 17/881,627

(22) Filed: Aug. 5, 2022

(30) Foreign Application Priority Data
Aug. 6, 2021 (KR) 10-2021-0104002

(51) Int. Cl. B29C 65/22

(52) U.S. Cl. CPC B29C 65/222; B29L 2031/7146

(57) ABSTRACT

The disclosure relates to a heating device capable of uniform sealing, uniformly applying heat at a constant temperature to the entire sealing portion of the to-be-sealed object to heat and seal the entire sealing portion at a constant temperature, thereby providing the uniform sealing thickness. A heating device capable of uniform sealing according to the disclosure comprises a heater for heating the sealing portion of the to-be-sealed object; a heat source supplier for supplying a heat source for heating to the heater; a heat transfer part accommodated in the heater, and transferring the heat source to the heater to heat the entire heater at a uniform temperature, and an additional heat transfer part disposed on the outer surface of the heat transfer part to conduct the heat source to the heater and in contact with the inner surface of the heater.

### CROSS-REFERENCE TO RELATED APPLICATION(S)

This application is based on and claims priority under 35 U.S.C. § 119 to Korean Patent Application No. 10-2021-0104002, filed on Aug. 6, 2021, in the Korean Intellectual Property Office, the disclosure of which is incorporated by reference herein in its entirety.

### TECHNICAL FIELD

Various embodiments of the disclosure relate to a heating device capable of uniform sealing, more particularly, a heating device capable of uniform sealing which may minimize the temperature difference of the component that heats the to-be-sealed object, when heating the to-be-sealed object at a certain temperature to seal the object.

### DISCUSSION OF RELATED ART

Recently, second batteries which can be charged and discharged have been widely used as an energy source for wireless mobile devices.

Further, the secondary battery has attracted considerable attention as a power source for electric vehicles (EV) and hybrid electric vehicles (HEV) which have been developed to solve problems, such as air pollution, caused by existing gasoline and diesel vehicles using fossil fuels.

Small-sized mobile devices use one or several battery cells for each device. On the other hand, middle or large-sized devices, such as vehicles, use a middle or large-sized battery module having a plurality of battery cells electrically connected to one another as a part cell because high power and large capacity are necessary for the middle or large-sized devices.

Preferably, the middle or large-sized battery module is manufactured so as to have as small a size and weight as possible. For this reason, a prismatic battery or a pouch-type battery, which can be stacked with high integration and has a small weight-to-capacity ratio, is usually used as a battery cell of the middle or large-sized battery module. In particular, much interest is currently focused on the pouch-shaped battery because the pouch-shaped battery is lightweight and less likely to leak, and the manufacturing costs of the pouch-shaped battery are low.

As shown, a typical pouch for a lithium-ion polymer battery case has a multi-layered structure formed by sequentially stacking a polyolefin layer, an aluminum layer, and a nylon layer. As a thermal adhesion layer, the polyolefin layer has a heat adhesion property to function as a sealing member. As a metal layer, the aluminum layer serves as a base material to provide mechanical strength and a barrier layer against moisture and oxygen. The nylon layer functions as a base material and a protective layer.

A commonly used polyolefin-based resin layer may be formed of casted polypropylene (CPP).

The shape of such pouch-type secondary batteries is variable, and the volume and weight thereof are smaller than those of the other secondary batteries having the same capacity as that of the pouch-type secondary batteries.

Meanwhile, in a pouch-type secondary battery, a battery assembly including a negative electrode, a separator, and a positive electrode is placed in a pouch-type packaging material during the manufacturing process, an electrolyte is injected, and the edges are sealed. Then, the battery is activated through several charge/discharge cycles.

In this case, sealing is essential in pouch-type secondary batteries.

The reason is that the deterioration of the sealing quality causes problems directly related to safety, such as leakage of electrolyte (chemical) and fire.

The conventionally used sealing block seals the pouch using conductive heat by inserting a cartridge heater. At this time, the temperature is controlled by controlling the power supply to the cartridge heater using a controller. Even if the power supply is constant, temperature non-uniformity occurs depending on the turns ratio inside the cartridge heater (even the identical product has a difference in turns ratio).

Recently, as the size of the pouch of the pouch-type secondary battery increases, the size of the sealing block is further increased. Therefore, it is impossible to secure the temperature uniformity technology only with the turns ratio of the cartridge heater; thus, the stability and reliability of the sealing quality rapidly deteriorate.

It is difficult to secure the reliability of the quality because the temperature difference within the sealing block is more than 10 degrees different (The appropriate temperature difference is within 3 degrees).

In the current cartridge method, efforts are made to match the turns ratio to ensure temperature uniformity. However, due to the processing and temperature characteristics, it is impossible to manufacture dozens of heaters that are applied in one line in the same way, deteriorating reliability.

In addition, when the heat of the cartridge heater is continuously lost in high-speed sealing, heat recovery within the block is very important, but it is challenging to recover beyond the material's thermal conductivity.

In the conventional large-sized pouch, which is 500 mm or more significant, the temperature non-uniformity of the cartridge heater is a big problem for stability, and there is no solution for heat loss and conductivity because there is no supplementary method other than the heat source of the heater.

### SUMMARY

According to an embodiment, the disclosure provides a heating device capable of uniform sealing, which may uniformly supply heat at a constant temperature to the entire sealing portion of the to-be-sealed object to allow sealing by heating the entire sealing portion to a uniform temperature, thereby providing a constant and uniform sealing thickness.

Further, the disclosure provides a heating device capable of uniform sealing, which may allow heat to rapidly circulate and transfer to the entire component that heats the to-be-sealed object in heating the to-be-sealed object to a certain temperature to seal the to-be-sealed object so that heat is evenly distributed, and the temperature difference is not generated and may minimize heat loss with a storage function.

A heating device capable of uniform sealing according to the disclosure comprises a heater for heating the sealing portion of a to-be-sealed object; a heat source supplier for supplying a heat source for heating to the heater; a heat transfer part accommodated in the heater and transferring the heat source to the heater to heat the entire heater at a uniform temperature; and an additional heat transfer part disposed on the outer surface of the heat transfer part to conduct the heat source to the heater and in contact with the inner surface of the heater.

Further, the heater is formed of nobinite or invar.

Further, the heater is provided with a first accommodating space for accommodating the heat source supplier and a second accommodating space for accommodating the heat transfer part along the longitudinal direction.

Further, the heater comprises blocking parts for closing both ends of the second accommodating space, and the blocking parts include at least one through-hole.

Further, the heat transfer part is formed of a heat pipe.

Further, the additional heat transfer part is formed of thermal grease and is injected between the outer surface of the heat transfer part and the inner surface of the heating part.

Further, comprised is an injection guide disposed to be spaced apart from each other at regular intervals along the circumferential surface of the heat transfer part to form a partition wall for partitioning the thermal grease injected between the heater and the heat transfer part.

The heating device capable of uniform sealing according to the disclosure applies a material having minor thermal deformation for a heater that heats the to-be-sealed object in contact with the sealing portion of the to-be-sealed object and applies a heat pipe capable of uniformly transferring heat to the sealing portion of the to-be-sealed object to uniformly supply heat at a constant temperature to the entire sealing portion of the to-be-sealed object, and this makes it possible to heat and seal the entire sealing portion to a uniform temperature, thereby having an effect in that the sealing thickness of the sealing portion is constant and uniform.

Further, in heating the to-be-sealed object to a certain temperature to seal the object, heat is rapidly circulated and transferred to the entire component that heats the to-be-sealed object so that heat is evenly distributed, and temperature difference does not occur. The heat storage function minimizes heat loss and recovers the lost heat at a fast speed, thereby increasing the sealing performance and quality.

Further, since it is possible to uniformly heat the entire part of the component that heats the to-be-sealed object at the desired temperature through heat circulation and heat transfer action, there is an effect that the entire sealing portion can be melted with properties suitable for sealing. Due to this, the sealing portion can be completely sealed within a small pressing force, low temperature, and a short time compared to the prior art.

### BRIEF DESCRIPTION OF THE DRAWINGS

A complete appreciation of the disclosure and many of the attendant aspects thereof will be readily obtained as the same becomes better understood by reference to the following detailed description when considered in connection with the accompanying drawings, wherein:

FIG. 1 is an exploded perspective view illustrating a heating device capable of uniform sealing according to an embodiment of the disclosure;

FIG. 2 is a combined perspective view illustrating a heating device capable of uniform sealing according to an embodiment of the disclosure;

FIG. 3 is a side view illustrating a heating device capable of uniform sealing according to an embodiment of the disclosure;

FIG. 4 is a half-sectional perspective view illustrating a heat transfer part applied to a heating device capable of uniform sealing according to an embodiment of the disclosure;

FIG. 5 is a front view illustrating the combined configuration of the heating device capable of uniform sealing according to an embodiment of the disclosure;

FIG. 6 is a cross-sectional view illustrating a configuration in which an additional heat transfer part and a blocking part are applied to a heating device capable of uniform sealing according to an embodiment of the disclosure;

FIG. 7 is a perspective view illustrating an example in which an injection guide part is applied to a heat transfer part applied to a heating device capable of uniform sealing according to an embodiment of the disclosure; and

FIG. 8 is a front view illustrating an example in which a heat transfer part and an additional heat transfer part of FIG. 7 are applied to the heater.

### DETAILED DESCRIPTION OF EXEMPLARY EMBODIMENTS

Advantages and features of the disclosure and methods of achieving them will become apparent regarding the embodiments described below in conjunction with the accompanying drawings.

However, the disclosure is not limited to the embodiments disclosed below, but may be implemented in various different forms, and only these embodiments allow the disclosure of the disclosure to be complete and is provided to fully inform those of ordinary skill in the art to which the disclosure pertains, the scope of the disclosure, and the disclosure is only defined by the scope of the claims. Like reference numerals refer to like elements throughout the specification.

Hereinafter, embodiments of the disclosure will be described in detail regarding the accompanying drawings so that those of ordinary skill in the art to which the disclosure pertains can easily carry out the disclosure. However, the disclosure may be embodied in several different forms and is not limited to the embodiments described herein. Throughout the specification, reference numerals are assigned to similar parts.

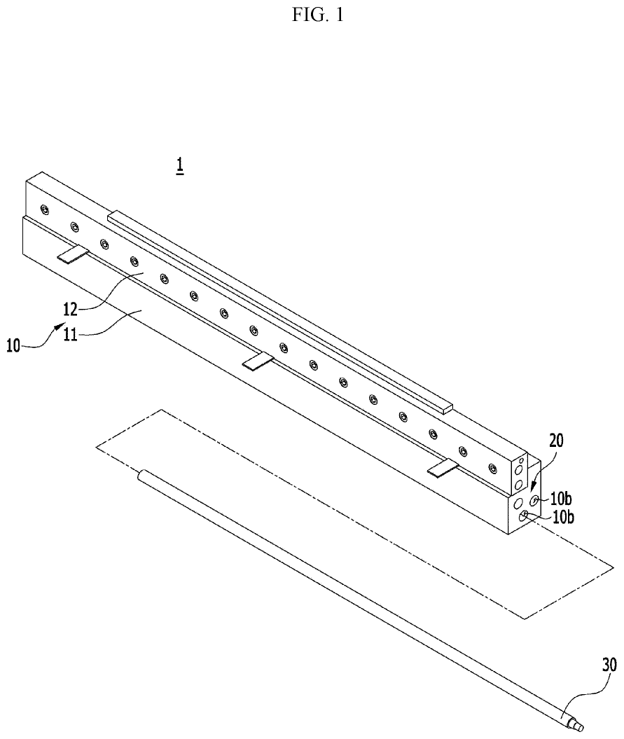

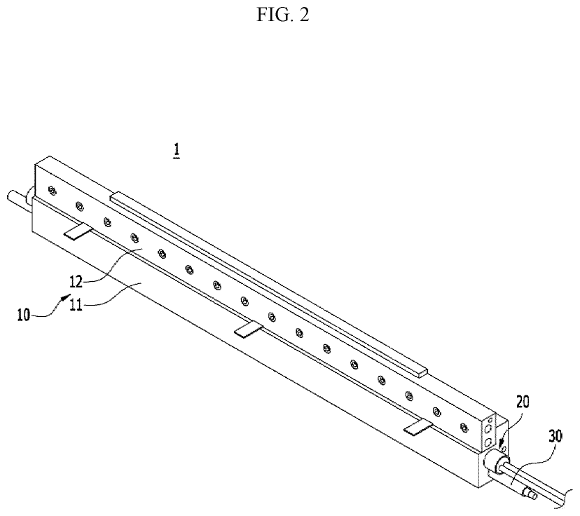

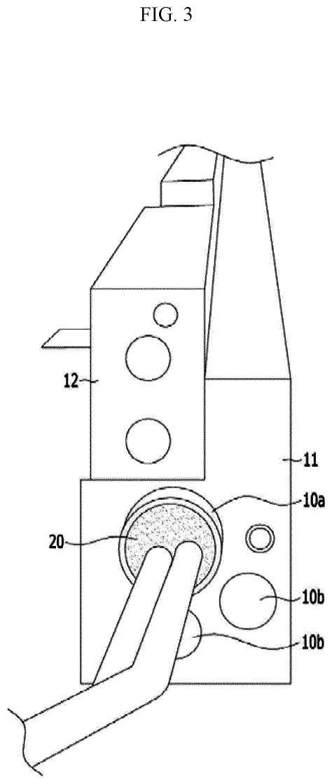

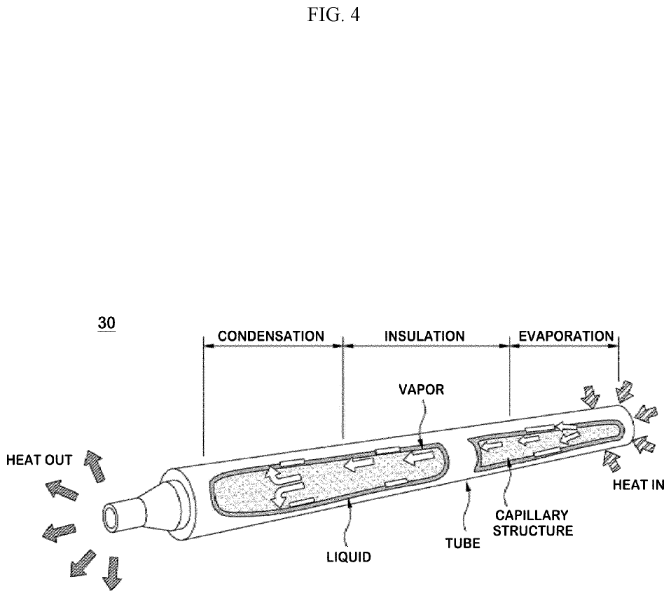

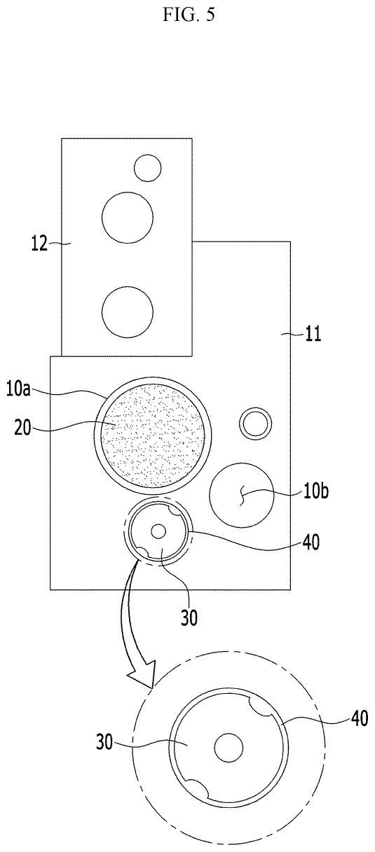

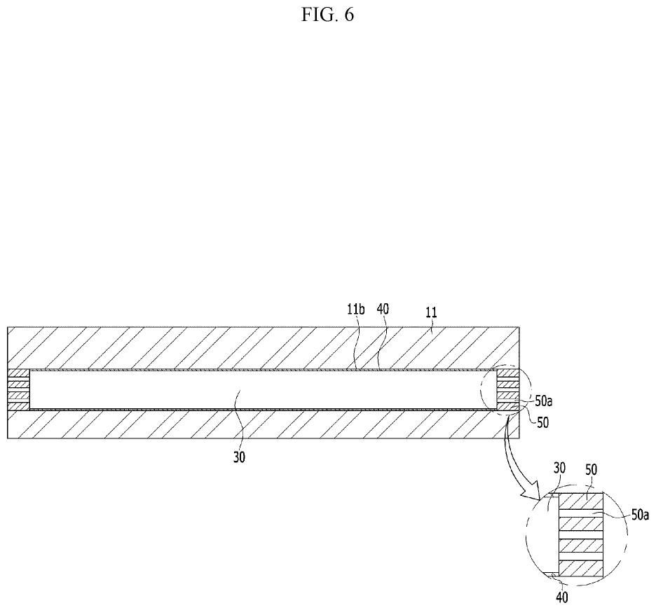

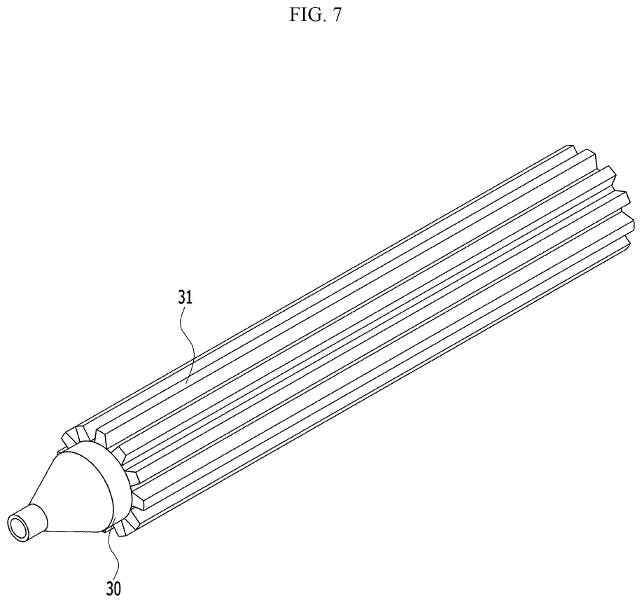

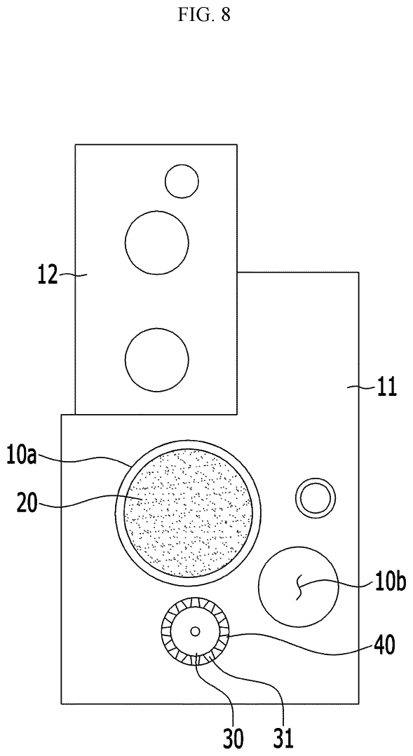

FIG. 1 is an exploded perspective view illustrating a heating device capable of uniform sealing according to an embodiment of the disclosure; FIG. 2 is a combined perspective view illustrating a heating device capable of uniform sealing according to an embodiment of the disclosure; FIG. 3 is a side view illustrating a heating device capable of uniform sealing according to an embodiment of the disclosure; FIG. 4 is a half sectional perspective view illustrating a heat transfer part applied to a heating device capable of uniform sealing according to an embodiment of the disclosure; FIG. 5 is a front view illustrating the combined configuration of the heating device capable of uniform sealing according to an embodiment of the disclosure; FIG. 6 is a cross-sectional view illustrating a configuration in which an additional heat transfer part and a blocking part are applied to a heating device capable of uniform sealing according to an embodiment of the disclosure; FIG. 7 is a perspective view illustrating an example in which an injection guide part is applied to a heat transfer part applied to a heating device capable of uniform sealing according to an embodiment of the disclosure; and FIG. 8 is a front view illustrating an example in which a heat transfer part and an additional heat transfer part of FIG. 7 are applied to the heating part.

The heating device capable of uniform sealing 1 according to an embodiment of the disclosure, is a product that can change its physical properties to a state that is easy to seal the sealing portion of the to-be-sealed object.

The to-be-sealed object may include various things, and hereinafter, an example in which a pouch-type secondary battery is applied as the to-be-sealed object will be described below.

The pouch-type secondary battery may generally comprise a cell body and a cell pocket.

The cell body and the cell pocket may be integrally formed by sealing the edges of the first and second surfaces of the same material and size.

Furthermore, the cell body may accommodate the electrode assembly and the electrolyte therein, and the cell pocket may be utilized to remove the gas present in the cell body.

Further, the heating device for sealing 1 according to the disclosure heats and melts the tab and pouch, the first pouch and the second pouch, etc., which are sealing portions of the secondary battery before sealing with the sealing device.

To this end, the heating device for sealing 1 according to the disclosure may comprise at least one heater 10, a heat source supplier 20, a heat transfer part 30, an additional heat transfer part 40, and a blocking part 50.

The heating unit 10 may comprise a first heating block 11 formed in an approximately ‘L’-shaped cross-sectional shape and a second heating block 12 disposed of in an upper stepped portion of the first heating block (11).

The first heating block 11 and the second heating block 12 may be formed of a material having excellent thermal conductivity.

The heater 10 is heated by a heat source supplier 20 to be described later. Further, in a state in which any one of the first heating block 11 and the second heating block 12 is in contact with the sealing portion of the secondary battery pouch, heat is transferred, and thermally fused.

A first accommodating space 10a in which the heat source supplier 20 is accommodated to form along the longitudinal direction of the first heating block 11.

Further, a second accommodating space 10b in which the heat transfer part 30 to be described later is accommodated to form along the longitudinal direction of the first heating block 11 and the second heating block 12.

As not shown in the figures, a first accommodation space in which the heat source supplier 20 is accommodated may also be formed in the second heating block 12.

In this case, the number of applications of the first accommodating space 10a and the second accommodating space 10b and the heat source supplier 20, and the heat transfer part 30 accommodated therein is not limited in the disclosure.

In other words, the first accommodating space 10a, the second accommodating space 10b and the heat source supplier 20, and the heat transfer part 30 accommodated therein are applied one by one or two or more of each of the first accommodating space 10a, the second accommodating space 10b, the heat source supplier 20 and the heat transfer part 30 may be applied to increase the thermal conductivity while quickly heating the heater 10.

Further, the figures show an applied example in which one first accommodating space 10a is formed in the first heating block 11, and two-second accommodating spaces 10b are formed in each of the first heating block 11, and the second heating block 12.

The first heating block 11 and the second heating block 12 described above may be formed of nobinite or invar.

First, nobinite may be formed from any one of CN-5, CD-5, CS-5, CF-5, and SI-5.

CN-5 is suitable for parts requiring low thermal expansion due to relatively high temperatures.

CN-5 has the property of expanding smaller than silicon at high temperatures.

CD-5 and CS-5 are suitable for parts where low thermal expansion and strength are essential. Its coefficient of thermal expansion is similar to that of SILICON WAFER, and it has high strength properties superior to invar.

CF-5 has a high damping ability after low thermal expansion.

SI-5 has properties equivalent to super invar, and its coefficient of thermal expansion is close to zero.

SI-5 is a material that can cope with thermal expansion better than general invar (ALLOY36).

The physical properties of such nobinite are shown in Table 1 below.

Table 1 of nobintie's physical properties

TABLE 1

| Properties | CN-5 | CD-5 | CS-5 | CF-5 | SI-5 |
|---|---|---|---|---|---|
| Coefficient of thermal | 4.5 × 10⁻⁶ | 2.8 × 10⁻⁶ | 1.2 × 10⁻⁶ | 2.5 × 10⁻⁶ | 0.42 × 10⁻⁶ |
| expansion (50° C.) | | | | | |
| Coefficient of thermal | 3.5 × 10⁻⁶ | 3.4 × 10⁻⁶ | 1.5 × 10⁻⁶ | 3.0 × 10⁻⁶ | 0.76 × 10⁻⁶ |
| expansion (100° C.) | | | | | |
| Tensile strength (N/mm²) | 550 | 400 | 500 | 200 | 500 |
| Proof stress (N/mm²) | 350 | 220 | 300 | | 270 |
| Brinell Hardness | 230 | 170 | 200 | 130 | 160 |
| Degree of Elongation (%) | 5 | 18 | 20 | | 15 |
| Young's module (N/mm²) | 137000 | 127000 | 137000 | 88000 | 137000 |
| Specific gravity | 8.2 | 7.8 | 8.0 | 7.8 | 8.0 |
| Thermal conductivity | 0.278 | 0.209 | 0.206 | 0.209 | 0.209 |
| (J/Cm, Sec, ° C.) | | | | | |
| Poisson's ratio | 0.37 | 0.33 | 0.36 | 0.27 | 0.36 |
| Specific heat (J/g, ° C.) | | 0.4556 | 0.4867 | 0.4598 | 0.4867 |

As shown in Table 1 above, it can be confirmed that all CN-5, CD-5, CS-5, CF-5, and SI-5 have low coefficients of thermal expansion at 50° C. and 100° C., and tensile strength, proof stress, and excellent Brinell hardness. The degree of elongation, the modulus of elasticity, and the thermal conductivity are more than twice that of the existing metal heating block.

The heater (10) using these nobinites as the primary material, can heat and seal the sealing portion to a uniform temperature without thermal deformation even when the temperature difference between the central part and both side parts is 10° C.

In other words, the heater 10 uniformly supplies heat at a constant temperature to the entire sealing portion, thereby heating the entire sealing portion to a uniform temperature so that the sealing thickness is constant.

Meanwhile, invar is a type of cast iron, meaning invariant steel, has a minimal coefficient of thermal expansion, and has the characteristics of not being rusted.

Invar is called Kovar, a low thermal expansion alloy, such as NILO K and Alloy K.

The components of Invar (based on Invar36) include 60% Fe, 35 to 38% Ni, 1.0% Co, 0.60% Mn, 0.50% Cr, 0.50% Mo, 0.35% Si, 0.10% C, 0.025% S, and 0.025% P.

The types of invar include NILO 36 (Invar-36), NILO 365, NILO 42 (Invar-42), NILO 475, NILO 48 (Invar-48), NILOMAG 77, and NILO-K (Kovar). The heating device capable of uniform sealing according to the embodiment of the disclosure may use anyone selected from among the above types.

NILO 36 has a specific gravity of 8.11 g/cm³ and a melting range of 1430° C.

NILO 36 is a nickel-iron alloy containing 36% nickel and has a low expansion coefficient.

In particular, NILO 36 does not expand at all at room temperature, shows a low coefficient of expansion even at 260° C., and has excellent strength and toughness at low temperatures.

NILO 365 has a specific gravity of 8.11 g/cm³ and a melting range of 1334° C. to 1409° C.

NILO 365 is a heat-reinforced, age-hardened, low-expansion alloy, which is a higher-strength, lower-expansion alloy than a nickel-iron mixed alloy.

NILO 42 has a specific gravity of 8.11 g/cm³ and a melting range of 1435° C.

NILO 42 is a nickel-iron expansion-controlling alloy including 42% nickel and has a low coefficient of thermal expansion from room temperature to 300° C.

NILO 475 has a specific gravity of 8.18 g/cm³ and a melting range of 360° C.

NILO 475 is a nickel-iron-chromium expansion-controlling alloy including 47% nickel and has thermal expansion properties that match well with lead and soda-lime type soft glass at permissible temperatures.

NILO 48 has a specific gravity of 8.20 g/cm³ and a melting range of 1450° C.

NILO 48 is a nickel-iron expansion-controlling alloy including 48% nickel.

NILOMAG 77 has a specific gravity of 8.77 g/cm³.

NILOMAG 77 is a nickel-iron alloy with copper and molybdenum added and a low loss soft magnetic alloy with a high initial penetration rate.

NILO-K has a specific gravity of 8.16 g/cm³ and a melting range of 1450° C.

NILO-K is a nickel-iron-cobalt expansion-controlling alloy including 29% nickel and has the characteristic that the expansion coefficient decreases as the temperature rises to the inflection point.

The heater 10 using these invars as the primary material can heat and seal the sealing portion to a uniform temperature without thermal deformation even when the temperature difference between the central part and both side parts is 10° C.

In other words, the heater 10 uniformly supplies heat at a constant temperature to the entire sealing portion, thereby heating the entire sealing portion to a uniform temperature so that the sealing thickness is constant.

The heat source supplier 20 supplies a heat source to the heater 10 so that the heater 10 heats the sealing portion.

The heat source supplier 20 may be formed of a cartridge heater comprising a round bar accommodated in the first accommodating space 10a and forming an exterior and a nichrome wire accommodated in the round bar and formed in a coil shape.

The nichrome wire may generate heat by receiving external power.

When the heat source supplier 20 is heated, heat is conducted to the heater 10, and the heater 10 is heated to heat the sealing portion.

Depending on the pouch-type secondary battery, the heater 10 may be prepared in various lengths.

At this time, even if the heat source supplier 20 supplies the heat source to the heater 10 in reality, the entire heater 10 does not generate heat at a uniform temperature.

In other words, both sides of the heat source supplier 20 are heated at a lower temperature than the center, and thereby both sides of the heater 10 are also heated at a lower temperature compared to the center of the heater 10.

Further, the temperature difference between the center and both sides of the heater 10 is about 10° C. to about 20° C.

When the sealing portion is heated with the heated heater 10 as described above, the temperature of the heat transferred to the part in contact with the central portion of the heater 10 among the sealing portion is different from the temperature of the heat transferred to the part in contact with both sides thereof. As a result, there is a problem that the entire sealing portion is not uniformly heated.

The heat transfer part 30 has a configuration applied to address these issues.

In other words, the heat transfer part 30 transmits the heat source along the longitudinal direction of the heater 10 so that the entire heater 10 is heated at a uniform temperature.

To this end, the heat transfer unit 30 may be formed of a heat pipe, which is illustrated in FIG. 4.

The heat pipe as the heat transfer part 30 has a thermal conductivity of about 500 times higher than platinum, about 1,300 times higher than copper, and about 2,000 times higher than a general hot water pipe.

The inside of the heat transfer part 30 is vacuum-treated, and a certain amount of liquid (working fluid) is filled therein.

When the heat source supply unit 20 heats the heater 10, heat is applied to one end (right), the working fluid is evaporated, and it moves to the opposite side (left) due to the pressure difference.

Since the right side is cold, the heat in the evaporated working fluid is removed, and the gas is changed to liquid again. That is, the liquid-gas state is repeatedly changed and circulated within the heat transfer part 30.

Then, the working fluid changes into a liquid and returns to its original position along a wick of the inner surface of the heat transfer part 30. In other words, the phase change between liquid and gas occurs and heat transfer occurs actively.

Accordingly, the right side of the heat transfer part 30 is heated by the heat source of the heat source supplier 20 transferred from the heater 10 in a state accommodated in the second accommodation space 10b. While the embedded working fluid is repeatedly cycled of evaporation (heat absorption) and condensation (heat dissipation), heat transfer is instantaneous (about 3 seconds per M) without a separate power source or ancillary equipment, and heat transfer is performed with thermal conductivity of approximately 98.5% so that the entire heater 10 can be heated at almost the same temperature.

Meanwhile, the heat pipe, which is the heat transfer part 30, does not form a perfect circle having the same outer diameter because the round bar body forming the exterior is made of copper.

That is, since the outer surface of the heat transfer part 30 is uneven as shown in FIG. 4, the entire outer surface does not completely contact the inner surface of the heater 10 but only intermittently contacts the inner surface of the heater 10.

In this case, the heat of the heat transfer part 30 is not efficiently transferred to the heater 10 due to the non-contact region, so the entire heater 10 cannot be heated at a uniform temperature.

The additional heat transfer part 40 has a configuration applied to address these issues.

To this end, the additional heat transfer part 40 is formed of thermal grease and is disposed of on the outer surface of the heat transfer part 30.

As an example, the heat transfer part 30 and the additional heat transfer part 40 may be applied to the heater 10 in a manner in which thermal grease, which is the additional heat transfer part 40, is evenly applied to the entire outer circumferential surface of the heat transfer unit 30, and then accommodates the heat transfer part 30 in the second accommodating space 10b.

As another example, after accommodating the heat transfer part 30 in the second accommodating space 10b, the additional heat transfer part 40 may be injected between the outer surface of the heat transfer part 30 and the inner surface of the heater 10.

In this case, the additional heat transfer part 40 may be filled in an injection device such as the known silicon gun and may be injected between the outer surface of the heat transfer part 30 and the inner surface of the heater 10 by the injection device.

When the additional heat transfer part 40 is applied to the outer surface of the heat transfer part 30 or the additional heat transfer part 40 is injected between the outer surface of the heat transfer part 30 and the inner surface of the heater 10, the additional heat transfer part 40 is in contact with the inner surface of the heater 10.

Thermal grease is a material that transfers heat and fills a fine space between the outer surface of the heat transfer part 30 and the inner surface of the heater 10 to increase the thermal conductivity of the heat transfer part 30 to the heater 10.

When the heat transfer part 30 and the additional heat transfer part 40 are applied to the heater 10, the temperature difference between the central portion of the heater 10 and both side portions thereof is reduced to within ±3° C., thereby heating the entire sealing portion at almost the same temperature so that eventually, the entire sealing portion may be sealed uniformly.

It is revealed that the temperature difference between the central portion and both side portions of the heater 10 may vary depending on the size, material, thickness, size, length, and other requirements of the heater 10.

Furthermore, since the heating device for sealing capable of uniform sealing 1 according to an embodiment of the disclosure may uniformly heat the entire area of the heater 10 to a desired temperature through the heat transfer part 30, the entire sealing portion may be melted with properties suitable for sealing, so that the sealing device may completely seal the sealing portion within a shorter time, less pressing force and low temperature compared to in the prior art.

Therefore, it is possible to increase the sealing force of the sealing portion. It is possible to prevent cracks in the sealing portion compared to the conventional sealing method only with a sealing device. It is possible to prevent the sealing portion from being excessively deformed or melted in shape and physical properties due to the high temperature of the sealing device. It is possible to perfectly seal the entire sealing portion in a uniform shape.

Further, the heat transfer part 30 has a heat storage function to minimize heat loss, thereby improving sealing performance and quality.

Meanwhile, the blocking part 50 has a configuration in which the heat transfer part 30 is accommodated in the second accommodation space 10b, and it is then inserted into both ends of the second accommodation space 10b to close.

The blocking part 50 includes a heat insulating material with low or no thermal conductivity, preventing heat loss in the second accommodation space 10b from leaking to the outside, and preventing the heat transfer part 30 from leaving the outside.

In this case, at least one through-hole 50a may be formed in the blocking part 50.

The pressure generated in the second accommodation space 10b by the operation of the heat source supplier 20 is discharged to the outside through the through-hole 50a to prevent the internal pressure of the heater 10 from increasing, thereby ensuring product stability.

Next, another embodiment of the heat transfer part 30 applied to the heating device capable of uniform sealing 1 according to an embodiment of the disclosure will be described regarding FIGS. 7 and 8.

FIG. 7 is a perspective view illustrating an example in which an injection guide part is applied to a heat transfer part applied to a heating device capable of uniform sealing according to an embodiment of the disclosure, and FIG. 8 is a front view illustrating an example in which a heat transfer part and an additional heat transfer part of FIG. 7 are applied to the heater.

As shown in FIGS. 7 and 8, the injection guide part 31 may be formed on the circumferential surface of the heat transfer part 30.

The injection guide parts 31 are formed to be spaced apart from each other at a predetermined distance along the circumferential surface of the heat transfer part 30.

The injection guide part 31 may be formed to be long in the longitudinal direction of the heat transfer part 30.

The injection guide part 31 may be formed of the same material as the heat transfer part 30.

For example, after the heat transfer part 30 is prepared, the injection guide part 31 may be separately coupled thereto.

For another example, the injection guide part 31 may be integrally formed when the heat transfer part 30 is prepared. In this case, the heat transfer part 30 and the injection guide part 31 may be integrally formed by a molding die.

After the heat transfer part 30 is accommodated in the second accommodation space 10b, the additional heat transfer part 40 is injected between the injection guide units 31 so that the additional heat transfer part 40 may be partitioned, and the additional heat transfer part 40 may be easily injected by the guide of the injection guide part 31.

Those of ordinary skill in the art to which the disclosure pertains will understand that the disclosure may be embodied in other specific forms without changing the technical spirit or essential features thereof. Therefore, it should be understood that the embodiments described above are illustrative in all respects and not restrictive. It should be understood that the scope of the disclosure is indicated by the claims to be described later rather than the above-detailed description, and all changes or modifications derived from the meaning and scope of the claims and their equivalent concepts are included in the scope of the disclosure.

What is claimed is:

1. A heating device capable of uniform sealing, comprising:
a heater for heating the sealing portion of to-be-sealed object;
a heat source supplier for supplying a heat source for heating to the heater;
a heat transfer part accommodated in the heater and transferring the heat source to the heater to heat the entire heater at a uniform temperature; and
an additional heat transfer part disposed on the outer surface of the heat transfer part to conduct the heat source to the heater and in contact with the inner surface of the heater.

2. The heating device of claim 1, wherein the heater is formed of nobinite or invar.

3. The heating device of claim 1, wherein the heater is provided with a first accommodating space for accommodating the heat source supplier and a second accommodating space for accommodating the heat transfer part along the longitudinal direction.

4. The heating device of claim 3, wherein the heater further comprises blocking parts for closing both ends of the second accommodating space, and
wherein the blocking parts include at least one through-hole.

5. The heating device of claim 1, wherein the heat transfer part is formed of a heat pipe.

6. The heating device of claim 1, wherein the additional heat transfer part is formed of thermal grease.
